(19) United States
(12) Patent Application Publication
(10) Pub. No.: US 2014/0107543 A1
(43) Pub. Date: Apr. 17, 2014

(54) SCALP STIMULATION AND HAIR RE-GROWTH

(71) Applicant: Ali Daniel Pazouki, Brentwood, TN (US)

(72) Inventor: Ali Daniel Pazouki, Brentwood, TN (US)

(21) Appl. No.: 13/652,170

(22) Filed: Oct. 15, 2012

(51) Int. Cl. A61H 1/00; H02K 15/00

(52) U.S. Cl. CPC A61H 1/00; H02K 15/00
USPC 601/72; 601/46; 29/596

(57) ABSTRACT

A method and an apparatus are disclosed for promoting hair growth using multi-dimensional vibrations. A multi-vibrating device includes components, such as electric motors, configured to generate several modes of vibration simultaneously. The vibrations may be transmitted to scalp or other skin area where re-growth of hair is desired via elements of the vibrating device such as bristles on a hairbrush. The multi-mode vibrations may cause natural skin oils and sebum surrounding the hair shaft and follicle to be stripped off to allow more oxygen and stimulate growth. The multi-mode vibration device may be used in conjunction with specially fortified shampoos and vitamins to further stimulate hair growth.

### TECHNICAL FIELD

This application relates generally to hair re-growth. More specifically, this application relates to a method and apparatus for providing scalp massage and stimulation using multi-dimensional vibrations delivered via a vibrating device.

### BRIEF DESCRIPTION OF THE DRAWINGS

The drawings, when considered in connection with the following description, are presented for the purpose of facilitating an understanding of the subject matter sought to be protected.

FIG. 1 shows an example baldness pattern;

FIG. 2 shows an example multi-vibrating hairbrush usable for scalp stimulation;

FIG. 3A shows an example battery operated multi-vibrating hairbrush;

FIG. 3B shows an example multi-vibrating hairbrush powered via an electrical cord;

FIG. 3C shows an example rechargeable battery operated multi-vibrating hairbrush;

FIG. 4 shows an example cutaway of a hairbrush revealing an internal electric motor coupled with an off-center weight configured to generate vibrations;

FIG. 5 show example electric motor coupled with a sliding linkage configured to generate reciprocal vibrations;

FIG. 6A shows an example side view of an electric motor coupled with a cam configured to generate multi-dimensional vibrations in a scalp stimulation device;

FIG. 6B shows an example top view of the electric motor of FIG. 6A; and

FIG. 7 shows an example multi-vibration hair brush with multiple off-center motors.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references handheld devices and hairbrushes, it will be appreciated that the disclosure may include other stationary devices, such as those used in commercial settings, and the like.

Briefly described, a method and an apparatus are disclosed for promoting hair growth using multi-dimensional vibrations. A multi-vibrating device includes components, such as electric motors, configured to generate several modes of vibration simultaneously. The vibrations may be transmitted to scalp or other skin area where re-growth of hair is desired via elements of the vibrating device such as bristles on a hairbrush. The multi-mode vibrations may natural skin oils and sebum surrounding the hair shaft and follicle to be stripped off to allow more oxygen and stimulate growth. The multi-mode vibration device may be used in conjunction with specially fortified shampoos and vitamins to further stimulate hair growth.

Hair loss is an enduring issue for most people, both male and female, who generally prefer to have hair than not. Various studies indicate that 40% of men have noticeable hair loss by age 35, 65% by age 60, and 80% by age 80. Hair loss affects women to a lesser but nevertheless significant extent. Studies show that about 80% of women will experience some hair loss by the age of 60. In bald patches follicles are still making hairs, but less well than before. The hairs get shorter and shorter over time until they are either barely visible or do not even break the skin's surface.

More than 95% of hair thinning in men is male pattern baldness, or androgenic alopecia, characterized by hair receding from the lateral sides of the forehead and/or a thinning crown. This hair loss pattern becomes more pronounced with age. Although, the extent of baldness varies from population to population based on genetic background, the same patterns are universally visible. Environmental factors do not seem to affect this type of baldness greatly.

One of the known triggers for male pattern baldness is DiHydroTestostrone (DHT), a sex hormone, which promotes body and facial hair growth and inhibits growth of the hair on scalp. But, factors other than DHT may also trigger and/or cause hair thinning and hair loss. For example, an unhealthy scalp environment can play a significant role in hair thinning by contributing to miniaturization or causing damage to hair follicles. Air and water pollutants, environmental toxins, conventional styling products and excessive amounts of sebum (An oily secretion of the sebaceous glands) may cause build-up on the scalp. This debris can block hair follicles and cause their deterioration and consequent miniaturization of hair. It can also physically restrict hair growth or damage the hair cuticle, leading to hair that is weakened and easily broken off before its natural lifecycle has ended. Additionally, hair mites, tiny spider-like creatures, are thought to be responsible for hair loss.

Hair growth may be stimulated by increased blood flow to the scalp which is one of the factors needed in hair growth. Cleaning the scalp by removing sebum build-up in the hair follicles is another factor that promotes hair growth or re-growth. Removing hair mites may also contribute to the health and re-growth of hair.

Thus, it is desirable to minimize the adverse effects of environmental causes of baldness to promote healthy hair growth.

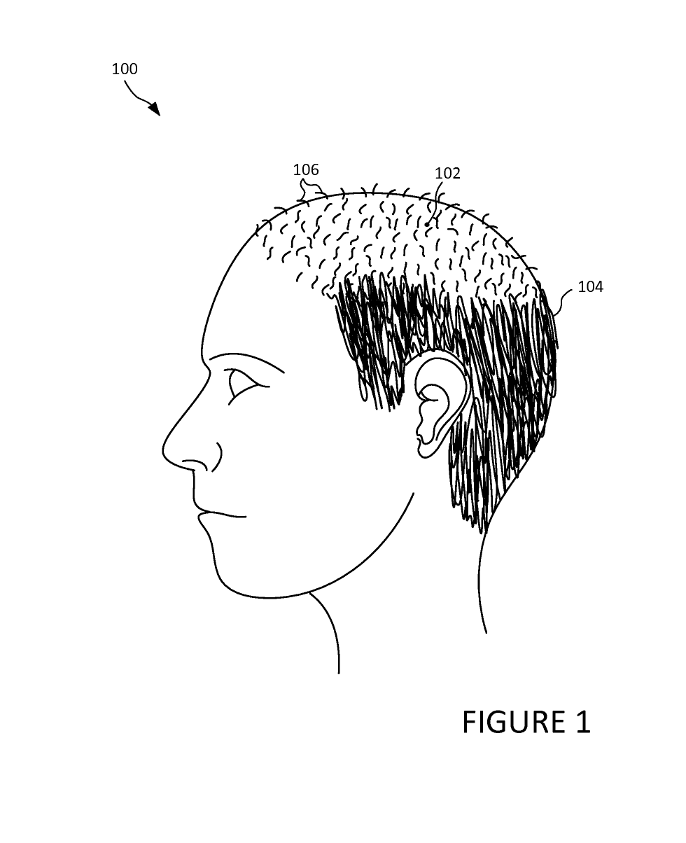

FIG. 1 shows an example baldness pattern. Male baldness pattern 100 generally includes a ring of hair 104 around scalp 102 with normal thickness, and missing or thin and short hair 106 on the crown. This pattern starts developing with receding frontal hair line on the sides and the appearance of thinning or bald patches on the crown. In time, these receding areas may join together creating a completely bald crown with a smaller and thinner ring of hair around the head. In women the baldness pattern is somewhat different in that it starts later, it is less pronounced and the frontal hairline is retained while the hair on the crown is thinned.

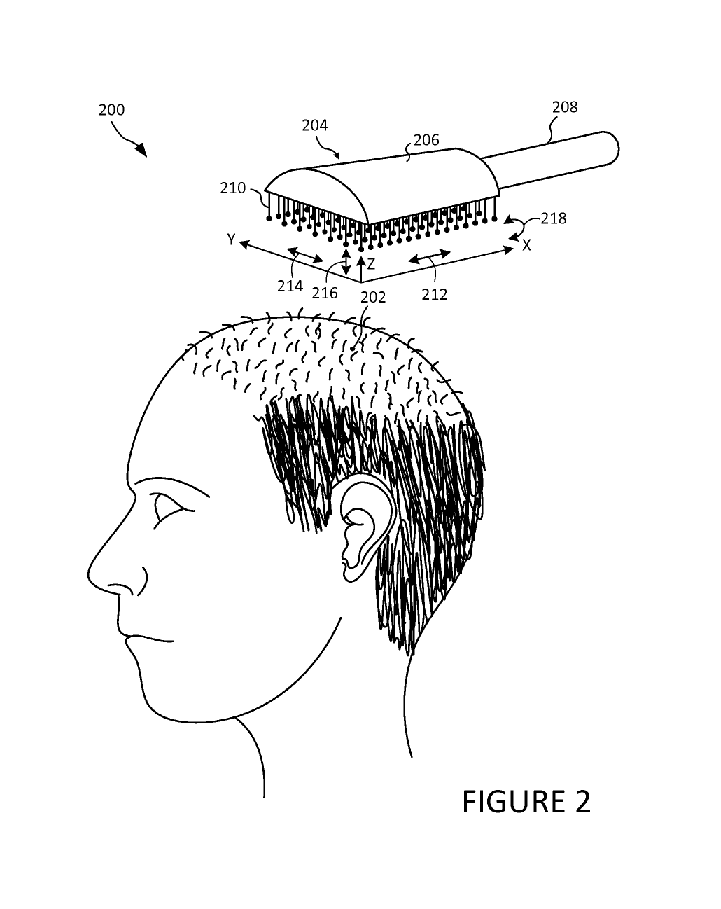

FIG. 2 shows an example multi-vibrating hairbrush usable for scalp stimulation. Arrangement 200 includes a person with balding area 202 using a multi-vibrating brush 204 having bristle section 206, handle 208, and bristles 210. In various embodiments, bristle section 206 or bristles 210 may be configured to vibrate in one or more dimensions or directions 212, 214, and 216, and/or vibrate in a circular motion 218.

The multi-dimensional vibration delivered by brush 20 may be configured to vibrate in one or more linear directions 212, 214, and 216, and/or vibrate in a circular motion 218. The linear directions may be substantially perpendicular with respect to the other linear directions or be at some angle, different from zero and 90 degrees, with respect to them.

The multi-dimensional vibration delivered by the vibrating device, such as brush 204 engaging the scalp via bristles 210, stimulates the scalp and may also cause scalp build-ups due to natural hair grease, residual remains of various chemicals such as shampoos and hair tonics, and the like to be scaled off and removed. The removable of scalp buildup helps free the hair follicles from being enclosed and isolated from air, thus promoting healthy hair re-growth.

In various embodiments, the multi-vibrating device may be different from a hair brush. For example, the vibrating device may include only a few larger fingers or shafts with suitably soft tips which massage the scalp by vibratory motion. In some embodiments, the fingers may have individual rotational motion. In other embodiments, such individual rotational motion may be combined with other modes of vibration, such as up and down vibrations with respect to the surface of the scalp. In still other embodiments, the vibrating device may include moving rollers which traverse a predetermined distance back and forth on a path on the scalp, which path may be linear or curved, to impart a gentle pressure wave over the scalp to massage the scalp.

In some embodiments, the vibrating device may be a hand-held device like a hair brush, while in other embodiments, the vibrating device may be configured as a scalp massaging station. The massaging station may enclose the user's scalp like a large hat and impart the massaging motions and vibrations via components such as bristles, fingers, rollers, and the like.

In some embodiments, the multi-vibrating device may vibrate in its entirety with respect to the user's hand or head, while in other embodiments, the device is configured in two main parts, a static part which is stationary with respect to the user's hand or head and a vibrating part which vibrates relative to the static part.

In some embodiments, a contact surface of the multi-vibrating device is curved to allow more contact between the vibrating device and the generally curved scalp. For example, the brush head including the bristle section of the hair brush may be made as a curved section like a shallow cup, which makes more extensive contact with the scalp and increases the efficiency of the multi-vibrating device in agitating or massaging the scalp.

Generally, growth of new hair related to the stimulation by the multi-vibrating device, may result in new hair with its original color. For example, if the remaining hair on a balding head is grey, any new hair growth may be in the original hair color, such as black, brown, red, blond, and the like.

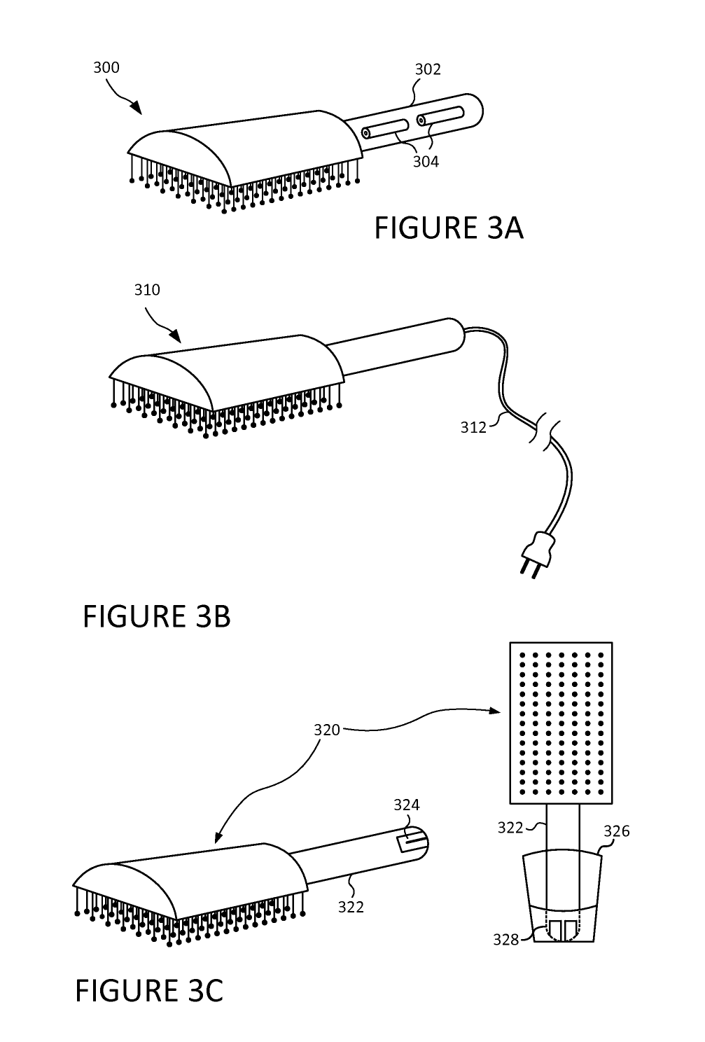

FIG. 3A shows an example battery operated multi-vibrating hairbrush. In various embodiments, the vibrating device, such as hair brush 300, includes a handle 302 which holds batteries 304 for its operation. In this configuration, the handheld vibrating device is easily transportable and may be easily handled for moving around the scalp to cover various areas of the scalp.

FIG. 3B shows an example multi-vibrating hairbrush powered via an electrical cord. In various embodiments, the vibrating device, such as hair brush 310, includes an electrical cord for supplying power for vibration. In this embodiment, the vibrating device has a stable source of power which is not diminished due to prolonged use, as may happen when using batteries.

FIG. 3C shows an example rechargeable battery operated multi-vibrating hairbrush. In various embodiments, the vibrating device, such as hair brush 320, includes an electrical plug or receptacle 324 coupled with a part of the vibrating device, such as handle 322, further electrically coupled with rechargeable batteries for its operation. The receptacle (or plug) 324 is configured to be coupled with a plug (or receptacle) 328 in charging station 326. In this configuration, the handheld vibrating device is easily recharged, is transportable, and may be easily handled for moving around the scalp to cover various areas of the scalp.

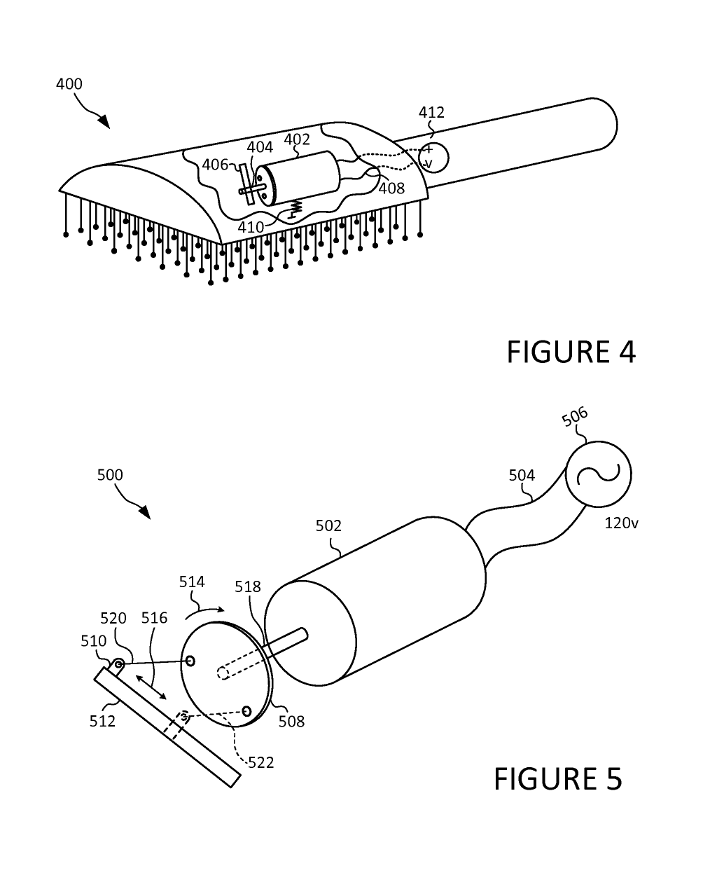

FIG. 4 shows an example cutaway of a hairbrush revealing an internal electric motor coupled with an off-center weight configured to generate vibrations. In various embodiments, vibrating device 400 includes an electric motor or armature 402 having shaft 404 and electric power wires 408 coupled with power source 412. Shaft 404 is coupled with weight 406 in an off-center rotation configuration. Armature 402 may be coupled with an elastic member such as spring 410 to aid in generating steady vibrations.

In operation, the armature generates vibrations in conjunction with vibration inducing mechanisms which convert or transform the rotational motion of the armature to reciprocating or periodic motion. Specifically, when the armature 402 is turned on, the off-center mounted weight 406 creates rotational imbalance causing a variable centrifugal force, which in turn creates vibratory and cyclical motion of the vibrating device, in conjunction with the force imparted by spring 410. The vibrations are substantially in the plane of the rotation of weight 406 and substantially traverse a circular path if no constraints are deployed to limit the motion of the device, or vibrating component of the device, in a particular direction. The frequency of vibration is substantially a function of the rotational speed of the armature.

In some embodiments, The vibration frequency of vibrations is predetermined or fixed to be a few hundred Revolutions Per Minute (RPM), such as 300-500 RPM, while in other embodiments, the vibrations may be adjusted by the user by adjusting the rotational speed of the motor, for example, using a control knob.

FIG. 5 show example electric motor coupled with a sliding linkage configured to generate reciprocal vibrations. In various embodiments, vibration generation system 500 includes armature 502 having power wires 504 coupled with power source 506. Armature 502 includes shaft 518 coupled with a driving component 508 which is in turn coupled with, via linkage 520 and pin joints 510, and drives member 512 in reciprocating motion 516. In effect, driving component 508 converts circular motion 514 of the motor to the linear reciprocating motion of the driven member 512. This arrangement is similar to a locomotive drive train.

In various embodiments, motor 502 is coupled with a motion conversion or transformation device to convert the rotational motion of the motor to a periodic or reciprocating motion. Specifically, motion follower member 512 is rigidly coupled with a vibrating component of the vibrating device (for example, the head portion of a brush moving with respect to a stationary handle of the brush), while the motor and driving component 508 are rigidly coupled with the stationary component of the vibrating device. Thus, when the motor runs, it causes the driving component 508 to rotate and drive a reciprocating or vibrating motion of the vibrating component of the vibrating device via member 512. In some embodiments, the motion follower member 512 moves back and forth in a linear path.

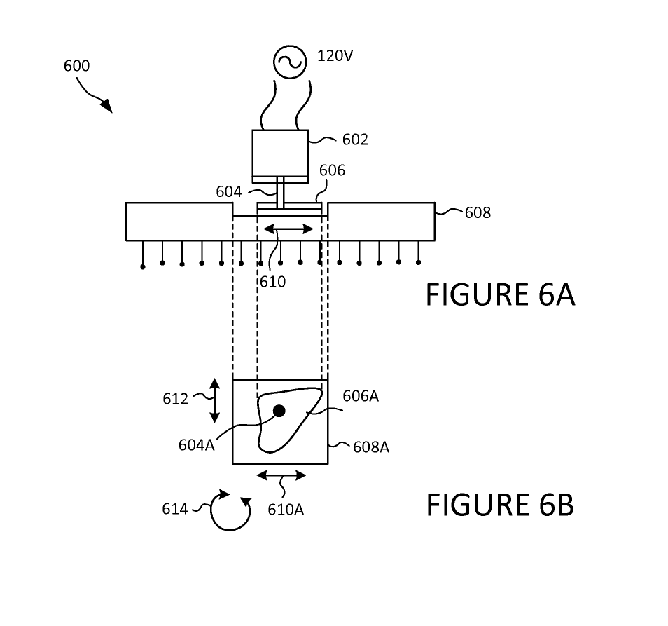

FIG. 6A shows an example side view of an electric motor coupled with a cam configured to generate multi-dimensional vibrations in a scalp stimulation device. In some embodiments, vibrating device configuration 600 includes motor 602 having shaft 604 and cam 606 coupled with cam follower or vibrating component 608 to generate multi-dimensional cyclical motions 610 (and 610A, FIG. 6B), 612, and 614 of vibrating component with respect to motor 602 and the housing of the motor.

Those skilled in the art will appreciate that a cam may be designed to implement various cyclical path of motion within the plane of rotation of the cam. Thus different vibration modes may be designed using different cams and cam followers. In various embodiments, the vibrating component 608 may move in different directions along linear paths, along a curved or circular path, up and down, side to side in various directions, or a combination of some or all of the above. In some embodiments, these movements are small, fast (higher frequency), and vibratory in nature to induce stimulating physical tremors in the scalp, while in other embodiments, the movements may traverse longer strokes, be slower (lower frequency) to massage the scalp and encourage blood flow. In still other embodiments, the type of vibratory motions or stimulation may be changed under user control. For example, the user may use one operating mode to vibrate the scalp vigorously to clean off build-up and hair mites, and then switch to another operating mode gently massage the scalp.

FIG. 6B shows an example top view of the electric motor of FIG. 6A. This view of cam 606A rotating about motor shaft or axis 604A shows cam follower 608A configured to cyclically move in a predetermined path based on the design of the cam. Thus, a multi-dimensional vibration pattern may be realized, with the cam follower simultaneously or sequentially, depending on mechanical constraints imposed on the cam follower, moving in different directions and paths in a periodic and continuous manner.

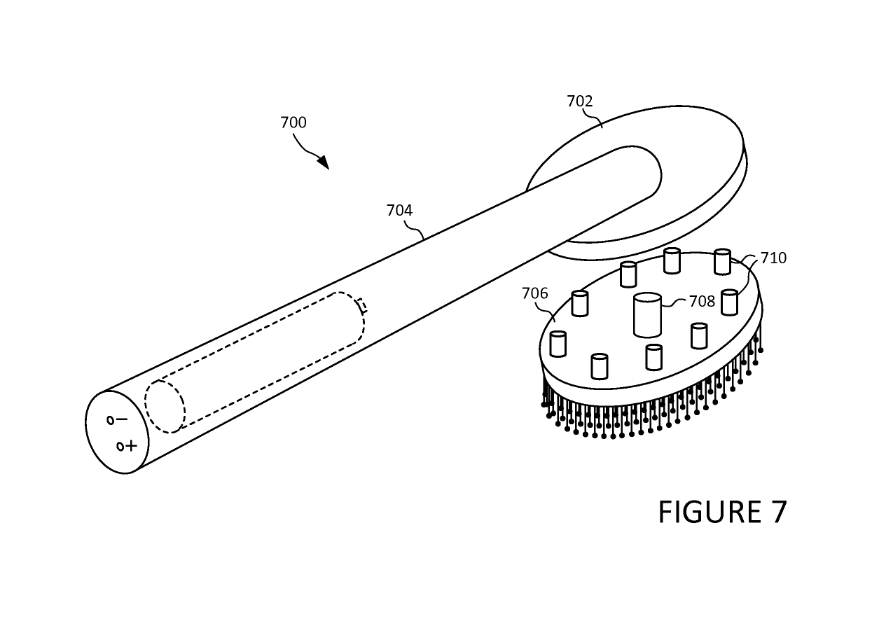

FIG. 7 shows an example multi-vibration hair brush with multiple off-center motors. In various embodiments, hair brush 700 includes brush head 702, brush handle 704, vibrating component 706 having off-center large motor 708 and off-center small motors 710.

In some embodiments, multiple off-center motors, which are dynamically imbalanced using an off-center weight, as described with respect to FIG. 4, created multiple modes of vibration depending on relative rotational speeds of the motors, distribution of the motors over the vibrating component, sequential activating and deactivating (ON/OFF) of various motors, various orientations of the motors relative to other motors, size of the off-center weights on different motors, extent the off-center weights are away from the neutral center of rotation (center of gravity), and the like. In some embodiments, the mode and intensity of vibrations may be controlled by the user of the hairbrush by changing the rotational speed on selected ones of the multiple off-center motors, or by turning selected ones of the motors OFF or ON.

In some embodiment, the multiple off-center motors have different sizes and powers compared with other motors. For example, one larger motor may be deployed at the center of the vibrating component, and several smaller motors may be deployed around the larger motor. Those skilled in the art will appreciate that many other configurations of motors and their placements may be employed without departing from the spirit of the present disclosures. For example, larger motors may be placed near the handle and smaller motors may be used going towards the tip of the brush away from the handle where due to larger leverage less power may be needed to provide uniform vibrations.

In some embodiments, brush head 702 is made of rubber or other similar elastic material, to allow smoother vibration of the vibrating component 706, dampen noise, and isolate the vibrations of the head from the handle the user holds. In other embodiments, the brush head is coupled to the non-vibrating component, such as the brush handle, with an elastic material like rubber.

Those skilled in the art will appreciate that other embodiments of the multi-vibrating device is possible without departing from the spirit of the present disclosures. For example, some of the embodiments described above may be combined to take advantage of various features of each, such as vibration in different modes and provision of power. Additionally, other vibration mechanisms are possible based on different known techniques for creating periodic motions, such as use of asymmetrical planetary gears.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A device for stimulating hair growth, the device comprising:
a vibrating component; and
an electric motor coupled with a motion transformation device attached to the vibrating component, the motion transformation device configured to convert a rotational motion of the electric motor to a reciprocating motion to generate multi-dimensional vibrations.

2. The device of claim 1, further comprising a static component coupled with the vibrating component.

3. The device of claim 1, further comprising a rechargeable battery coupled with the electric motor.

4. The device of claim 1, wherein the vibrating component is a head of a hair brush.

5. The device of claim 1, wherein the motion transformation device comprises an off-center weight.

6. The device of claim 1, wherein the motion transformation device converts a rotational motion to a reciprocating motion.

7. The device of claim 1, wherein the motion transformation device comprises a cam and cam follower mechanism.

8. The device of claim 1, wherein the multi-dimensional vibrations comprises at least two of vibrations in each of multiple linear directions and a circular path.

9. The device of claim 1, wherein a frequency of the multi-dimensional vibrations is adjustable by a user of the device for stimulating hair growth.

10. A device for stimulating hair growth, the device comprising:
a vibrating component; and
a plurality of off-center electric motors coupled with the vibrating component, the plurality of motors configured to generate multi-dimensional vibrations.

11. The device of claim 10, further comprising a non-vibrating component coupled with the vibrating component via an elastic component.

12. The device of claim 10, wherein the device for stimulating hair growth is a hair brush.

13. The device of claim 10, wherein the plurality of off-center electric motors are configured to be controlled by a user of the device to adjust the multi-dimensional vibrations.

14. The device of claim 10, wherein the multi-dimensional vibrations include at least two of vibrations in each of multiple linear directions and a circular path.

15. The device of claim 10, wherein the plurality of off-center electric motors are configured to be powered by a rechargeable battery.

16. A method of manufacturing a device for stimulating hair growth, the method comprising:
using a vibrating component;
coupling a plurality of off-center electric motors to the vibrating component, the plurality of motors configured to generate multi-dimensional vibrations.

17. The method of claim 16, further comprising coupling a rechargeable battery with the plurality of the off-center electric motors.

18. The method of claim 16, wherein the plurality of off-center motors have different sizes.

19. The method of claim 16, wherein the plurality of off-center electric motors are configured to be controlled by a user of the device to adjust the multi-dimensional vibrations.

20. The method of claim 16, wherein the multi-dimensional vibrations include at least two of vibrations in each of multiple linear directions and a circular path.
